(19) United States
(12) Patent Application Publication
(10) Pub. No.: US 2020/0063979 A1
(43) Pub. Date: Feb. 27, 2020

(54) LIGHTING DEVICE FOR A HOUSEHOLD APPLIANCE, AND HOUSEHOLD APPLIANCE

(71) Applicant: BSH Hausgeräte GmbH, Munich (DE)

(72) Inventors: Dominik Abele, Bruchsal (DE); Simon Hörter, Karlsruhe (DE); Ralf Wadlinger, Hockenheim (DE)

(21) Appl. No.: 16/610,928

(22) PCT Filed: Apr. 17, 2018
(86) PCT No.: PCT/EP2018/059716

§ 371 Date: Nov. 5, 2019

(30) Foreign Application Priority Data
May 11, 2017 (DE) 10 2017 208 003.5

(51) Int. Cl. F24C 15/20; F21V 5/00; F21V 7/00

(52) U.S. Cl. CPC F24C 15/2064; F21Y 2113/10; F21V 7/0091; F21V 5/007

(57) ABSTRACT

A lighting device for a household appliance includes at least two light sources and a lens body which is configured at least partially to have at least two lens cones associated to the two light sources in one-to-one correspondence. Each of the lens cones has a light exit surface.

The present invention relates to a lighting device for a household appliance and to a household appliance having such a lighting device.

The use of lighting devices in household appliances, in particular in extractor hoods, is known. In this regard, the lighting devices are used in particular to light a workspace which can comprise a hob, for instance. In other household appliances, such as baking ovens, the lighting device is used to illuminate the cooking compartment and in particular individual cooking levels there.

Known lighting devices from other sectors are described in WO 2009/153347A1, for instance. A reading lamp or spotlight is described here. With this light, the lighting device comprises at least four LEDs with a different tone and color (warm white; bright white; red; cyan). Moreover, an additional primary optic for focusing at a predetermined distance from the secondary optic with at least one microoptic is used for intermixing and light guidance purposes. One disadvantage of this lighting device is that this has a complex structure and requires a considerable overall height.

Furthermore, a lighting device with light-emitting diodes and a changeable color temperature is described in DE 10 2009 038 353 A1. In this regard, at least two LEDs with a different color spectrum which are connected electrically in parallel and passively with the power source are used, the light intensity of which is changed by changing the current intensity and the mixed light as a result has another color temperature. One disadvantage of this lighting device consists in light being output non-directionally and thus it not being possible to homogeneously illuminate a surface or an object.

The object of the present invention is therefore to create a lighting device which has a simple structure and by means of which a surface or an object can still be lit homogeneously and uniformly.

The knowledge underlying the invention is that this object can be achieved by at least two light sources having one lens with at least two lens cones being used.

The object is achieved according to a first aspect by a lighting device for a household appliance which has at least two light sources and a lens body. The lighting device is characterized in that at least two lens cones with in each case one light exit surface are embodied at least partially by the lens body and each light source is assigned a lens cone.

In accordance with the invention, a lighting device which is arranged in or on a household appliance and which can targetedly light a surface or a space in the household appliance or in the surroundings of the household appliance is understood to mean a lighting device for a household appliance. The household appliance preferably represents a kitchen household appliance. The household appliance can however also represent a lamp device, for instance a light strip for assembly below a wall-hanging cupboard. The household appliance can therefore represent an extractor hood, a baking oven, a refrigerator or a lamp device, for instance.

The invention is described below essentially with the example of a lighting device of an extractor hood. The invention is not restricted to this use of the lighting device, however.

The lighting device has at least two light sources and a lens body.

An optical element is referred to as lens body, in which the light beams output by the light source are directed and partially reflected. The lens body has a light outlet which preferably represents a flat surface. The lens body can represent a solid body, which can consist of plastic, for instance. Alternatively, it is however also possible to design the lens body so that this is formed by a reflector. In this embodiment the open side of the reflector can be open or be closed by a protective barrier, for instance made of glass. In the embodiment in which the reflector which forms the lens body is open, the light outlet represents the open side. With the provision of a protective barrier, the light outlet is formed by the protective barrier which is introduced in the reflector on the open side. In accordance with the invention, at least two lens cones are at least partially embodied by the lens body. A geometry on the lens body is referred to as lens cone and forms a surface which is arched convexly with respect to the light outlet. The lens cone can therefore have the form of a half round rod, for instance. The light cone is however preferably a geometry on the lens body, which is rotationally symmetrical and has a light exit plane which lies at right angles to the axis of rotation. In the longitudinal section the lens cone can therefore have the shape of a cone section of a straight circular cone. In particular, the longitudinal section of the lens cone can represent a parabola, a hyperbola or a pitch circle, in particular semicircle. The point at which the curved region of the lens cone intersects the axis of rotation is also referred to as focal point. With a rod-shaped geometry of the light cone, the point at which the axis of reflection intersects the convexly curved region is referred to as focal point. The area in the immediate vicinity of the focal point and at least one part of the curved surface of the lens body are formed on the lens body. Moreover, each lens cone has a light exit surface on the lens body. The light exit surface of each lens cone here represents one part of the light outlet of the lens body. A geometry of the lens body which forms part of the exterior of the lens body is referred to as the lens cone embodied by the lens body. The outer surfaces of the lens body which form the lens cone are designed so that these reflect light.

In accordance with the invention, a lens cone is assigned to each light source. This means that the light source is arranged on the lens cone so that the light output by the light source reflects in the lens cone and can be output at least partially through the light exit surface of the lens cone. The light source is therefore preferably arranged in the region of the focal point of the lens cone.

A series of advantages can be achieved in the present invention by the light being introduced from at least two light sources into a lens body and a light cone being embodied at least partially on the lens body for each light source. On the one hand, the structure of the lighting device is simplified. In particular, the number of parts is reduced, since neither a separate lens body has to be made available for each light source, nor is a secondary optic required in addition to the lens body.

According to one embodiment, the light exit surfaces of the lens cone in the lens body abut one another. In particular, the generally round light exit surfaces are arranged so that they strike one another at at least one point. With a rod-shaped lens cone, the light exit surface is strip-shaped and the at least two strip-shaped light exit surfaces abut one another along a longitudinal edge. In accordance with the invention, the light exit surfaces represent regions of the light outlet of the lens body and are thus not separate components. Since the lens cones are preferably formed by convex surfaces, the light leaves the light exit surface at least partially outward, in other words away from the axis of reflection or axis of rotation. The light beams are therefore fanned out at least partially. By the lens cones being arranged so that their light exit surfaces abut one another, the light which is output via the one light exit surface, at least in the region in which the light exit surfaces abut one another, is mixed. Therefore, the light temperature at least in the region in the vicinity of the contact point of the two light exit surfaces can be easily set by using different light sources or a different setting of the individual light sources, for instance. In the embodiment in which the light exit surfaces of the lens cones abut one another, with two lens cones the light outlet of the lens body can have the shape of an eight.

According to a preferred embodiment, the light exit surfaces of the lens cones partially overlap. The light exit surfaces preferably overlap only to the extent that the focal point of the one lens body lies in the vertical direction only above one of the light exit surfaces. In the embodiment of the overlapping light exit surfaces, the lens cones which are formed by the exteriors of the lens body are only partially present as outer surfaces of the lens body. In the overlapping region of the light exit surfaces, the lens cones also overlap. In the overlapping region, part of the individual lens cones is therefore not present as an outer surface of the lens body. The light exit surface of the individual lens cone is defined in accordance with the invention by imaginary integration of the geometry of the individual lens cone inside the lens body.

By the light exit surfaces of the individual lens cones overlapping, the light output by the individual light sources is not only mixed after leaving the light outlet of the lens body but already in the interior at least in the overlapping region of the lens body. Moreover, the light is also focused and directed. Therefore a light cone in which visible light is present and the color temperature is possibly uniform can therefore be generated below the light outlet at least in the space under the overlapping surface. In this way the light cone projects close to the light outlet of the lens body.

According to a preferred embodiment, at least one of the lens cones of the lens body is embodied as a TIR (total inner reflection) lens. In the embodiment in which the light exit surfaces overlap, the TIR lens ends at the overlapping region and merges into the overlapping region of the further TIR lens. A collimator which collimates the light beams leaving a light source, in particular punctifom light source, and allows these light beams preferably to escape at least partially parallel from the lens is referred to as a TIR lens. The TIR lens represents a combination of reflector and lens. Light is refracted and reflected in the TIR lens.

The lens body preferably consists of plastic. This material can be easily brought into the desired form. Moreover, the exterior of the lens body can be easily processed, for instance a specific reflection behavior set. Finally, the weight of plastic is generally lower than glass, so that the overall weight of the lighting device can be reduced.

The light source(s) of the inventive lighting device preferably comprise LED(s) (light-emitting diode). In other words, the light source comprises at least one LED. Conditioned by their functional principle, LEDs can only emit one specific color. This is dependent on the material of the semiconductor and its coating. Since at least two light sources with in each case at least one LED and moreover a shared lens body are used in the inventive lighting device, the color can be intentionally changed or a desired color temperature can be set. With the use of just one LED with or without a lens, only the brightness of the output light can be regulated. The color temperature of the LED used always remains the same. Moreover, LEDs are advantageous in that the thermal development during operation of the LED is minimal. Finally, LEDs can be easily dimmed.

According to a preferred embodiment, the light source comprises at least one white light LED. Within the meaning of the invention a light source which comprises at least one LED and is designed for this purpose to output light which appears colorless is understood to be a white light LED. The white light LED is preferably an LED arrangement, which comprises red, green and blue color LEDs (RGB colors). The fluorescent colors output by the individual color LEDs overall produce white light. Alternatively, a light source is however also referred to as white light LED, which comprises an LED which is a color LED, for instance blue color LED and which is combined with an internal fluorescent layer, for instance with luminescent dyes. On account of the short wavelength and thus the high energy of the blue light, the dyes are excited to illuminate, wherein yellow light is output. As a result white light is generated on account of additive mixing of the spectral colors. Other types of white light LEDs can also be used.

The use of white light LEDs enables the light output by the lighting device to be adjusted to the ambient light and for instance cooking on a hob lit by the lighting device to be made easier.

According to a particularly preferred embodiment, the light sources output light with color temperatures which differ from one another. The color temperature defines the temperature in Kelvin of a black body, to which a specific light color belongs. The lower the temperature, the redder (warmer) the light source is (appears). The higher the temperature, the bluer/purpler (colder) the light source is (appears). The wavelength of the light shortens when the temperature increases. The lower the temperature, the longer wave the light. An idealized thermal radiation source is referred to as a black body, which completely absorbs all electromagnetic radiation of any wavelength and outputs this simultaneously as thermal radiation.

The light sources can preferably each be a light source, which outputs light with a color temperature in the range of 2700K to 6500K for instance, or can be set in each case so that this can output a color temperature in this range. A light source particularly preferably outputs light with a color temperature which is referred to as warm white, and is at 2700K for instance, and one of the at least one further light sources outputs light with a color temperature which is referred to as cold white and is at 6500K for instance. Alternatively, the respective light sources can be set so that this light can be output with these color temperatures. The use of light sources, with which light with these color temperatures is output, can continuously vary the color temperature of the light output by the lighting device between cold white and warm white.

According to one embodiment, at least one light source is connected to a dimmer apparatus. An apparatus is understood to mean a dimmer apparatus, by means of which the brightness of the light output by a light source can be changed. With the inventive lighting device, it is therefore possible with light sources which output light with different color temperatures to change the color temperature of the light output by the lighting device by setting the brightness of the individual light sources. The color temperature can be set continuously as a result.

The dimmer apparatus can be a current intensity regulation unit or a pulse width modulation (PWM) unit for instance.

The lens body preferably has boreholes on the side facing the light exit surface of the lens cone, and one of the light sources is introduced into each of the boreholes. The light sources therefore immerse into the lens body. In particular, in one embodiment according to which the light source comprises an LED, at least the LED projects into the borehole. This ensures a reliable injection of the light output by the light source into the lens body.

According to a further aspect, the invention relates to a household appliance with at least one inventive lighting device. Advantages and features which were described in respect of the lighting device apply, where applicable, also to the household appliance and vice versa.

The household appliance is in particular a kitchen household appliance. The household appliance can be a baking oven, a refrigerator, a lamp device or an extractor hood. In a household appliance which represents a baking oven, the inventive lighting device can be provided in the ceiling of the oven muffle and/or in one of the side walls of the oven muffle. The upper cooking plane is therefore lit by means of the lighting device or an object, for instance food, located in a cooking level below is lit. In a refrigerator, the upper cooling level or objects on cooling levels located therebelow can be lit accordingly. A lamp device can represent a light strip, for instance, which can be mounted below a wall-hanging cupboard of a kitchenette. In this embodiment of the household appliance, the lighting device is arranged so that this light outputs downward. The lighting device is therefore used to light the workspace on a kitchenette for instance.

According to a preferred embodiment, the household appliance represents an extractor hood and the at least one lighting device is introduced in the extractor hood so that light is output downward from the extractor hood by way of the light exit surfaces. Since an extractor hood is generally arranged above a hob, the hob is lit by the lighting device. In addition, the workspace adjacent to the hob can also be lit by at least one lighting device.

A number of lighting devices are provided, these can therefore be individually mounted on the household appliance, in particular the extractor hood. Within the scope of the invention, a number of inventive lighting devices are also combined in a lighting module, as a result of which manufacture of the household appliance and maintenance is simplified.

One advantage of the inventive household appliance which represents an extractor hood is that the inventive lighting device can be easily integrated into the extractor hood housing on account of its small installation height. Moreover, when a hob is lit, it is desirable to set the color temperature of the light, since the light should not be perceived to be bothersome during the cooking process.

The invention is described again in more detail with reference to the accompanying drawings, in which:

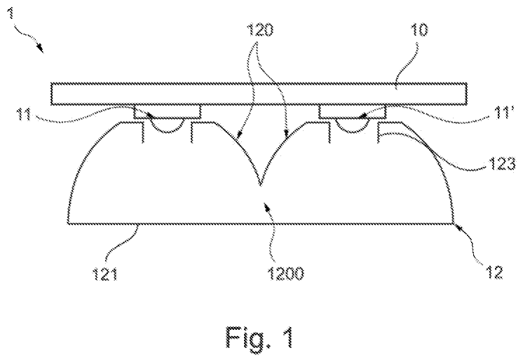

FIG. 1: shows a schematic sectional view of an embodiment of the inventive lighting device;

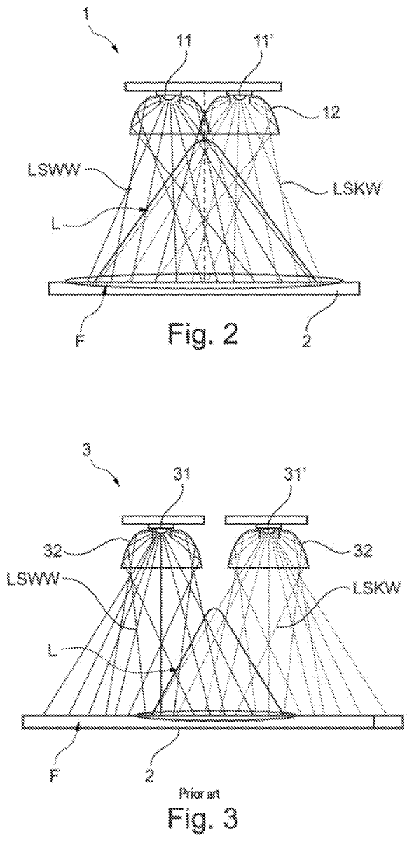

FIG. 2: shows the beam path of the embodiment of the lighting device according to FIG. 1;

FIG. 3: shows the beam path of the embodiment in a lighting device according to the prior art; and

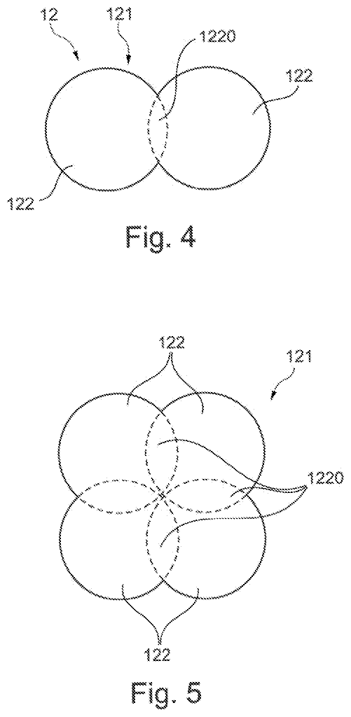

FIGS. 4 and 5: show schematic views from below of embodiments of the inventively used lens body.

FIG. 1 shows a schematic view of an embodiment of a lighting device 1 according to the present invention. Only the components essential to the invention are shown in the Figure. The lighting device 1 can also comprise a housing (not shown), connection lines for the power supply (not shown) and further elements for fastening (not shown) on the household appliance (not shown).

The lighting device 1 in FIG. 1 has two light sources 11, 11′ and a lens body 12. The light sources 11, 11′ are held on a support 10 in the embodiment shown, which can represent a printed circuit board for instance. Two lens cones 120 are formed in the lens body 12 and merge into one another. The lens cones 120 are therefore only partially formed by the exterior of the lens body 12, and merge into one another in the overlapping region 1200. The lower side of the lens body 12, which is also referred to as light outlet 121, is formed by the light exit surfaces 122 of the two lens cones 120 (see FIG. 4). Boreholes 123 are introduced into the lens body 12 in the side of the lens body 12 which is facing away from the light outlet 121. In the embodiment shown, the boreholes 123 are disposed in each case at the highest point on the first and second lens cone 120, in other words in the region of the focal point of the geometry of the lens cone 120. The light sources 11, 11′ are inserted into the respective boreholes 123 in the lens body 12. The light sources 11, 11′ preferably represent light sources with at least one LED.

In FIG. 2, the beam path of the light beams in the lighting device 1, in particular in the lens body 12 and below the lens body 12, is shown schematically, in particular relative to a cooker 2 which is arranged below the lighting device 1. The lighting device 1 has the structure shown in FIG. 1. It is assumed in FIG. 2 that the light source 11, which is shown on the left, is a white light LED, which outputs warm-white light, and the light source 11′ which is shown on the right is a white light LED which outputs cold white light. This is indicated schematically in FIG. 2 by the different dashings of the light beams LSWW, LSKW of the two light sources 11, 11′.

The light output from the light sources 11, 11′ is partially reflected in the lens body 12 and output by way of the light outlet 121. Here the beam cones which leave the lens body 12 from the first and second light source 11, 11′ in each case overlap below the lighting device. Since the light from the light source 11 and the light from the light source 11′ has different color temperatures, a light cone L is therefore present in the region in which the two beam cones overlap, in which light is present with a uniform color temperature distribution. On account of the geometry of the lens body 12, in particular on account of the overlapping light exit surfaces 122 of the two lens cones 120, the light cone L extends to just below the lower side of the lens body 12, in other words below the light outlet 121.

The light beam L strikes the cooker 2 and covers a surface F. This surface on the cooker is lit homogeneously with light of a uniform color temperature.

The color temperature can be continuously varied between the individual LEDs in accordance with the invention and in particular in the embodiment of the lighting device according to FIG. 1 by regulating the current intensity or by using pulse width modulation (PWM) of the individual LEDs.

In FIG. 3, the beam path of the light beams is shown schematically in one of the lighting device 3 according to the prior art. The lighting device 3 here has two separate lens bodies 32 at a distance from one another. A lens cone 320 is formed by each of the lens bodies 32. In particular, FIG. 3 shows the beam path of the light beams in the two lens bodies 32 and below the lighting device 3, in particular relative to a cooker 2, which is arranged below the lighting device 3. It is also assumed in FIG. 3 that the light source 31, which is shown on the left, is a white light LED, which outputs warm-white light, and the light source 31′, which is shown on the right, is a white light LED which outputs cold white light. This is indicated schematically in FIG. 3 by the different dashings of the light beams LSWW, LSKW of the two light sources 31, 31′.

On account of the distance between the two lens bodies 32, with this lighting device 3 the light cone L, in which homogeneous light is present with a uniform color temperature, is smaller, in other words does not extend so close from the cooker 2 to the lighting device 3, as with the inventive lighting device 1 shown in FIG. 2. Moreover, the diameter of the light cone L on the cooker 2 is also smaller. Surface F on the cooker, which is homogeneously lit with light with a uniform color temperature, is therefore smaller.

Views from below of two embodiments of lens bodies 12 of the inventive lighting device 1 are shown in FIGS. 4 and 5. FIG. 4 shows the view from below onto the lens bodies 12 of the embodiment of the lighting device 1 from FIG. 1. As apparent from this view, the light exit surfaces 122 of the first and second lens cone 120 overlap. The dashed lines in FIG. 4 show this. However, these dashed lines are not visible on the lens body 12. The light outlet 121 formed by the light exit surfaces 122 of the lens cone 120 is instead a continuous surface. The light exit surfaces 122 overlap in an overlapping surface 1220.

FIG. 5 shows the view from below onto the lens body 12 of an embodiment of the lighting device 1, in which four lens cones are formed. The light exit surfaces 122 of the four lens cones are indicated in FIG. 5. In this context these also do not represent separate surfaces, but instead together form the light outlet 121 of the lens body 12. In the embodiment shown, two light exit surfaces 122 each overlap a further light exit surface 122 arranged therebetween in an overlapping surface 1220. Other arrangements of the light exit surfaces 122 and thus other forms of the light outlet 121 are also possible, however.

In the embodiment of the lens body 12 according to FIG. 5, the lighting device 1 has four light sources (not shown), and each of the light sources is assigned to a lens cone (not shown).

With the embodiment of the lens body 12 according to FIG. 5, a combination of a number of white light LEDs can be realized with a different color temperature in each case. In this regard, a different color temperature can be achieved depending on the switching pairing of the LEDs, so that the individual LEDs do not need to be dimmed by varying the current intensity. A simple on/off circuit of the individual LEDs would be possible as a result.

With the present invention, it is possible to produce a lighting device, which can also be referred to as white light emitter (spot), in which the light temperature can be set continuously or successively between 2700K to 6500K for instance. The impinging light is perceived homogeneously and uniformly on the lit objects/surfaces and these are illuminated in a defined manner so that the lighting device can also be used with sufficient brightness as a working light or functional light. By means of the adjustable color temperature, the lighting device, in particular the white light emitter, can be adjusted to the ambient light and is no longer perceived to be a foreign or interfering light source.

On account of the inventive structure, it is possible with simple means to design a light spot with an adjustable color temperature while simultaneously homogeneously lighting surfaces or the workspace. In order to adjust the color temperature variably, at least two white light LEDs are preferably used in accordance with the invention. In combination with the lens body, which can also be referred to as collection lens, the light of the at least two LEDs is mixed by internal reflection and focused and directed at the same time so that the light of the individual LEDs with a different color temperature on the lit surfaces is perceived to be homogeneous and single-colored.

The lit region is therefore defined and brightened uniformly. By regulating the current intensity or by changing pulse width modulation (PWM) of the individual LEDs, the color temperature can be varied continuously between the individual LEDs. With a number of LEDs with a different color temperature, the setting can also take place using a switching pairing of the LEDs.

With the inventive lighting device, the light mixture is carried out closer to the light exit surface than is the case with two separate lenses with the same focal point on the workspace. This produces a homogeneous appearance clearly in front of the surface to be lit when observed horizontally by the user.

A significant advantage of this design is that this solution can be integrated into existing LED modules.

Furthermore, the invention has the advantage of the smallest required installation height, which, in any case, is required for a lens geometry designed for the workspace to be lit.

A further plus point, in addition to the significantly smaller space requirement, is the minimal number of parts compared with complex, multistage lens optics. On account of this minimalistic design, it is possible to produce a cost-effective lighting device, which can also be referred to as spot, the individual LEDs of which can be varied by a simple current intensity change in the brightness, in order thus to achieve the desired effect of adjusting the color temperature.

### LIST OF REFERENCE CHARACTERS

1 lighting device
10 support
11 light source
11′ light source
12 lens body
120 lens cone
1200 overlapping region
121 light outlet
122 light exit surface
1220 overlapping surface
123 borehole
L light cone
LSWW light beams warm white
LSKW light beams cold white
2 cooker
F homogeneously lit surface
3 lighting device (prior art)
31 light source (prior art)
31′ light source (prior art)
32 lens body (prior art)
320 lens cone (prior art)

1-12. (canceled)

13. A lighting device for a household appliance, comprising:
at least two light sources; and
a lens body configured at least partially to have at least two lens cones associated to the two light sources in one-to-one correspondence, each said lens cone having a light exit surface.

14. The lighting device of claim 13, wherein the light exit surfaces of the lens cone abut one another in the lens body.

15. The lighting device of claim 13, wherein the light exit surfaces of the lens cone partially overlap in the lens body.

16. The lighting device of claim 13, wherein at least one of the lens cones of the lens body is embodied as a TIR (Total Inner Reflection) lens.

17. The lighting device of claim 13, wherein the lens body is made of plastic.

18. The lighting device of claim 13, wherein at least one of the at least two light sources comprises an LED (Light Emitting Diode).

19. The lighting device of claim 13, wherein at least one of the at least two light sources comprises a white light LED.

20. The lighting device of claim 13, wherein the at least two light sources output light with color temperatures which differ from one another.

21. The lighting device of claim 13, further comprising a dimmer apparatus, at least one of the at least two light sources being connected to the dimmer apparatus.

22. The lighting device of claim 21, wherein the dimmer apparatus represents a current intensity regulation unit or a pulse width modulation unit.

23. The lighting device of claim 13, wherein the lens body has boreholes on a side facing a light outlet, with one of the at least two light sources being introduced into one of the boreholes and the other one of the at least two light sources being introduced into another one of the boreholes.

24. A household appliance, comprising a lighting device, said lighting device comprising at least two light sources, and a lens body including a light outlet and configured at least partially to have at least two lens cones associated to the two light sources in one-to-one correspondence, each said lens cone having a light exit surface.

25. The household appliance of claim 24, constructed in the form of an extractor hood, said lighting device being introduced in the extractor hood so that light is output downward from the extractor hood via the light outlet.

26. The household appliance of claim 24, wherein the light exit surfaces of the lens cone abut one another in the lens body.

27. The household appliance of claim 24, wherein the light exit surfaces of the lens cone partially overlap in the lens body.

28. The household appliance of claim 24, wherein at least one of the lens cones of the lens body is embodied as a TIR (Total Inner Reflection) lens.

29. The household appliance of claim 24, wherein the lens body is made of plastic.

30. The household appliance of claim 24, wherein at least one of the at least two light sources comprises an LED (Light Emitting Diode).

31. The lighting device of claim 24, wherein at least one of the at least two light sources comprises a white light LED.

32. The household appliance of claim 24, wherein the at least two light sources output light with color temperatures which differ from one another.

33. The lighting device of claim 24, wherein the lighting device includes a dimmer apparatus, at least one of the at least two light sources being connected to the dimmer apparatus.

34. The lighting device of claim 33, wherein the dimmer apparatus represents a current intensity regulation unit or a pulse width modulation unit.

35. The lighting device of claim 24, wherein the lens body has boreholes on a side facing a light outlet, with one of the at least two light sources being introduced into one of the boreholes and the other one of the at least two light sources being introduced into another one of the boreholes.
